(19) United States
(12) Patent Application Publication
(10) Pub. No.: US 2026/0288340 A1
(43) Pub. Date: Sep. 24, 2026

(54) MEMORY SYSTEM, INFORMATION PROCESSING DEVICE, AND INFORMATION PROCESSING SYSTEM

(71) Applicant: Kioxia Corporation, Tokyo (JP)

(72) Inventors: Shinichi MATSUKAWA, Shinagawa Tokyo (JP); Kazushi MIYAKE, Yokohama Kanagawa (JP)

(21) Appl. No.: 19/324,857

(22) Filed: Sep. 10, 2025

(30) Foreign Application Priority Data
Mar. 19, 2025 (JP) 2025-045470

(51) Int. Cl. G06F 3/06

(52) U.S. Cl. CPC G06F 3/0613; G06F 3/0659; G06F 3/0679

(57) ABSTRACT

A memory system includes a non-volatile memory including a plurality of memory cells, a volatile memory, and a memory controller. The memory controller is configured to write data of n bits of data (n being an integer of 3 or more) into each memory cell of the non-volatile memory, and perform non-volatilization to write data stored in the volatile memory into the non-volatile memory each time a second data amount, which is an amount of first write data that is currently stored in the volatile memory and has not been non-volatilized, reaches a first data amount. The memory controller is configured to, in response to a first request from the information processing device, transmit first size information indicating a first difference between the first data amount and the second data amount.

### CROSS-REFERENCE TO RELATED APPLICATIONS

This application is based upon and claims the benefit of priority from Japanese Patent Application No. 2025-045470, filed Mar. 19, 2025, the entire contents of which are incorporated herein by reference.

### FIELD

Embodiments described herein relate generally to a memory system, an information processing device, and an information processing system.

### BACKGROUND

A NAND flash memory is known as a semiconductor memory device, and a known memory system includes the NAND flash memory and a memory controller that controls the NAND flash memory. Also, an information processing device connectable to the memory system and an information processing system including the memory system and the information processing device are known.

### BRIEF DESCRIPTION OF THE DRAWINGS

FIG. 1 is a diagram illustrating a configuration of an information processing system according to an embodiment.

FIG. 2 is a block diagram illustrating a configuration of a memory system according to the embodiment.

FIG. 3 is a block diagram illustrating a configuration of an information processing device according to the embodiment.

FIG. 4 is a block diagram illustrating a configuration of a semiconductor memory device according to the embodiment.

FIG. 5 is a diagram illustrating a circuit configuration of a memory cell array in the semiconductor memory device according to the embodiment.

FIG. 6 is a diagram illustrating a threshold voltage distribution of a memory cell according to the embodiment.

FIG. 7 is a diagram illustrating a method of non-volatilization processing for data in a semiconductor memory device of a comparative example.

FIG. 8 is a sequence diagram illustrating an operation of an information processing system according to the embodiment.

FIG. 9 is a diagram illustrating a method of non-volatilization processing for data in the semiconductor memory device according to the embodiment.

FIG. 10 is a sequence diagram illustrating an operation of the information processing system according to the embodiment.

FIG. 11 is a flowchart illustrating the operation of the information processing system according to the embodiment.

### DETAILED DESCRIPTION

An object of embodiments is to improve efficiency of non-volatilization processing in a memory system when a predetermined request is received from an information processing device.

In general, according to an embodiment, a memory system is connectable to an information processing device. The memory system includes a non-volatile memory including a plurality of memory cells, a volatile memory, and a memory controller. The memory controller is configured to write data of n bits of data (n being an integer of 3 or more) into each memory cell of the non-volatile memory, and perform non-volatilization to write data stored in the volatile memory into the non-volatile memory each time a second data amount, which is an amount of first write data that is currently stored in the volatile memory and has not been non-volatilized, reaches a first data amount. The memory controller is configured to, in response to a first request from the information processing device, transmit first size information indicating a first difference between the first data amount and the second data amount.

According to another embodiment, an information processing device is connectable to a memory system including a non-volatile memory and a volatile memory. The information processing device includes a controller configured to transmit, to the memory system, a first command to perform non-volatilization of data stored in the volatile memory into the non-volatile memory. The controller is configured to differentiate a timing of transmitting the first command based on size information received from the memory system, the size information indicating a difference between a first data amount, the memory system performing the non-volatilization each time data of the first data amount has been stored in the volatile memory, and a second data amount, which is an amount of data that is stored in the volatile memory and has not been non-volatilized into the non-volatile memory.

Hereinafter, a memory system, an information processing device, and an information processing system according to one or more embodiments will be described in detail with reference to the drawings. In the following description, components having substantially the same functions and configurations are denoted by the same reference numerals, and will be described redundantly only when necessary. Each of the embodiments described below exemplifies a device and a method for embodying a technical idea of this embodiment. The technical idea of the embodiments is not limited by the materials, shapes, structures, arrangements, and the like of the components described below. Various modifications may be made to the technical idea of the embodiments in addition to the scope of the claims.

### 1. Overall Configuration of Information Processing System

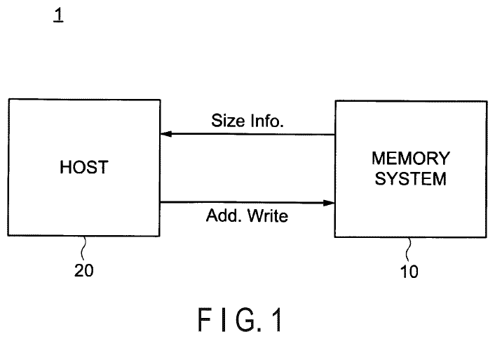

FIG. 1 is a diagram illustrating a configuration of an information processing system according to an embodiment. As illustrated in FIG. 1, an information processing system 1 includes a memory system 10 and a host device 20. The memory system 10 and the host device 20 can be connected to each other. In the present embodiment, the host device 20 is an example of an information processing device. In other words, in the following description, the “host device 20” can be replaced with an “information processing device”.

The host device 20 transmits a predetermined request (or a command) to the memory system 10. The memory system 10 executes predetermined processing in response to the received command, and notifies the host device 20 of the result. The predetermined request includes a data write request, a data read request, a sleep request, and a difference notification request. The sleep request is a request to transition the memory system 10 to a sleep mode when the host device 20 transitions to a sleep mode (may be referred to as a host sleep mode). In order to transition the memory system 10 to the sleep mode, it is necessary to execute processing for transferring data stored in a volatile memory of the memory system 10 to a non-volatile memory. Such processing is referred to as “non-volatilization processing”.

In the memory system 10, non-volatilization processing may be executed in units of data of a predetermined amount. Although details will be described below, when n bits (for example, n being an integer equal to or greater than 3) can be stored in one memory cell, the non-volatilization processing in the non-volatile memory in the memory system 10 is executed in units of data of a predetermined amount (hereinafter, referred to as a “first data amount”). Here, in a state where there is a large difference between the amount of data stored in the volatile memory of the memory system 10 and the first data amount, when dummy data is written to the volatile memory to fill the difference in a case of performing the non-volatilization processing in response to the request from the host device 20, or the non-volatilization processing is executed using a mode of storing one bit in one memory cell, usage efficiency of the non-volatile memory will deteriorate.

To address such an issue, in the information processing system 1 according to the present embodiment, before the host device 20 transitions to the sleep mode, the host device 20 requests the memory system 10 to notify of the difference between the amount of data stored in the volatile memory and the first data amount. Such a request is a “difference notification request”. When the memory system 10 receives the difference notification request from the host device 20, the memory system 10 notifies the host device 20 of size information (Size Info.) indicating the difference between the amount of data currently stored in the volatile memory and the first data amount.

The host device 20 adjusts a timing of transmitting a sleep request to the memory system 10 according to the received size information, and transmits an additional write request (Add. Write). Specifically, the host device 20 transmits the sleep request when it is determined that the amount of data stored in the volatile memory reaches the first data amount. Then, the host device 20 transitions to the sleep mode.

In the following description, the difference notification request may be referred to as a “first request”. In contrast, the sleep request may be referred to as a “second request” or a “first command”. A first data amount is an amount of data designated when a memory controller 100 performs the non-volatilization processing in response to the sleep request.

### 2. Overall Configuration of Memory System

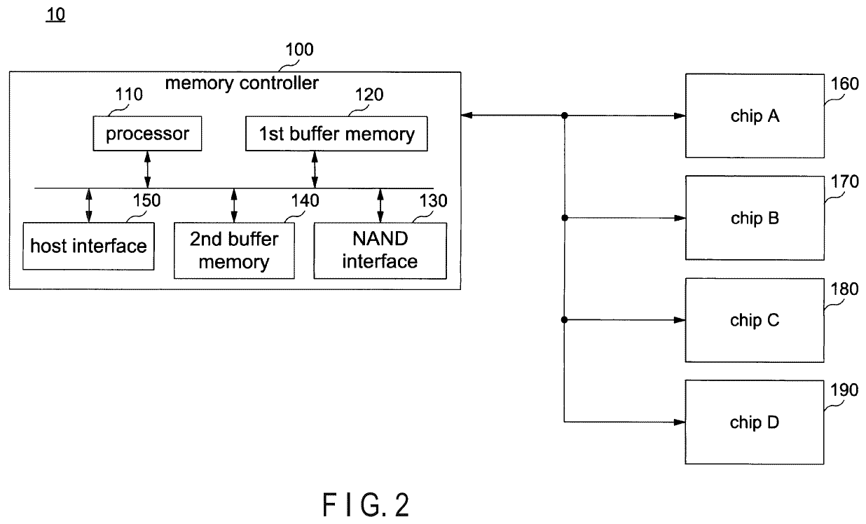

FIG. 2 is a block diagram illustrating a configuration of the memory system according to the embodiment. As illustrated in FIG. 2, the memory system 10 according to the present embodiment includes the memory controller 100 and semiconductor memory devices 160 to 190 (chips A to D). The memory controller 100 is connected to the semiconductor memory devices 160 to 190 via a bus. Non-volatile memory such as NAND flash memory are used as the semiconductor memory devices 160 to 190. The memory controller 100 controls operations of the semiconductor memory devices 160 to 190.

The memory controller 100 instructs the semiconductor memory devices 160 to 190 to execute a write operation, a read operation, non-volatilization processing, sleep processing, and difference calculation in response to the write request, the read request, the sleep request, and the difference notification request, respectively, received from the host device 20. Here, the sleep processing means processing for causing the memory system 10 to transition to the sleep mode.

When the memory controller 100 receives the write request from the host device 20, the memory controller 100 instructs the semiconductor memory devices 160 to 190 to write, and thus a write operation is executed in response to the write request. When the memory controller 100 receives a read command, the memory controller 100 instructs the semiconductor memory devices 160 to 190 to read, and thus a read operation is executed in response to the read request. When the read operation is executed, the memory controller 100 transmits data, which are stored in the semiconductor memory devices 160 to 190, to the host device 20.

When the memory controller 100 receives the sleep request from the host device 20, the memory controller 100 stores the data stored in the volatile memory in the semiconductor memory devices 160 to 190 to execute the non-volatilization processing. When the memory controller 100 receives the difference notification request, the memory controller 100 calculates the difference between the amount of data stored in the volatile memory and the first data amount, and notifies the host device 20 of information indicating the calculated difference.

Each of the semiconductor memory devices 160 to 190 includes a plurality of memory cells and stores data in a non-volatile manner. The semiconductor memory devices 160 to 190 are semiconductor chips that can be individually identified. For example, the semiconductor memory devices 160 to 190 are identified by individual chip enable signals. Alternatively, the semiconductor memory devices 160 to 190 are identified by assignment of individual chip addresses to the semiconductor memory devices in advance, respectively. Therefore, the semiconductor memory devices 160 to 190 are independently controlled by instructions from the memory controller 100.

The memory controller 100 transmits various signals to the semiconductor memory devices 160 to 190 via the bus, and receives various signals from the semiconductor memory devices 160 to 190. The bus includes a plurality of signal line, and transmits and receives according to the instructions transmitted from the memory controller 100. The signals transmitted and received via the bus include, for example, a chip enable signal, a command latch enable signal, an address latch enable signal, a write enable signal, a read enable signal, an output instruction signal, a write protect signal, a data signal (including a data strobe signal), and a ready/busy signal.

As illustrated in FIG. 2, the memory controller 100 includes a processor 110, a first buffer memory 120, a NAND interface circuit 130, a second buffer memory 140, and a host interface circuit 150.

The processor 110 is, for example, a central processing unit (CPU), and controls operations of the memory controller 100 as a whole. The processor 110 performs non-volatilization processing with respect to data stored in the first buffer memory 120 or the second buffer memory 140 according to the sleep request received from the host device 20, for example, and performs sleep processing on the memory system 10. Specifically, the processor 110 transfers data, which is stored in the first buffer memory 120 or the second buffer memory 140, to the semiconductor memory devices 160 to 190 via the NAND interface circuit 130. The sleep processing is processing for causing the memory system 10 to transition to a sleep mode.

The first buffer memory 120 is, for example, a semiconductor memory such as a static random access memory (SRAM) or a dynamic RAM (DRAM), and is used as a working region of the processor 110. The first buffer memory 120 stores firmware for managing the semiconductor memory devices 160 to 190, various management table, and the like. The first buffer memory 120 may be embedded in the memory controller 100, or may be provided outside the memory controller 100.

The NAND interface circuit 130 is connected to the semiconductor memory devices 160 to 190 via the bus described above, and communicates with the semiconductor memory devices 160 to 190. The NAND interface circuit 130 transmits an operation instruction, an address, and write data to the semiconductor memory devices 160 to 190 in response to the instruction from the processor 110. The NAND interface circuit 130 receives status and read data from the semiconductor memory devices 160 to 190.

The second buffer memory 140 is a volatile memory that temporarily stores the data and the like that the memory controller 100 receives from the host device 20 and the semiconductor memory devices 160 to 190. In other words, before the write data received from the host device 20 is stored in the semiconductor memory devices 160 to 190, the memory controller 100 temporarily stores the write data in the second buffer memory 140. As the second buffer memory 140, for example, a semiconductor memory such as an SRAM or a DRAM is used. In other words, the processor 110 controls the non-volatile memories (the semiconductor memory devices 160 to 190) and the volatile memory (the second buffer memory 140). When the memory system 10 is in the sleep mode, the power supplied to the second buffer memory 140 is limited or the power is shut off, whereby the data stored in the second buffer memory 140 may be lost. In the present embodiment, the first buffer memory 120 and the second buffer memory 140 are separate components, but these functions may be implemented by a single buffer memory. In this case, the single buffer memory is divided into a first volatile region and a second volatile region, the first volatile region plays a role similar to that of the first buffer memory 120, and the second volatile region plays a role similar to that of the second buffer memory 140.

The host interface circuit 150 is connected to the host device 20 and executes data communication with the host device 20. For example, the host interface circuit 150 transfers the commands received from the host device 20 to the processor 110 and the second buffer memory 140, respectively.

### 3. Overall Configuration of Host Device

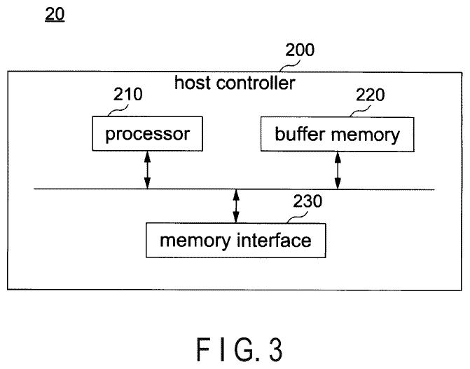

FIG. 3 is a block diagram illustrating a configuration of the information processing device according to the embodiment. As illustrated in FIG. 3, a host controller 200 in the host device 20 according to the present embodiment includes a processor 210, a buffer memory 220, and a memory interface circuit 230. These components are connected to each other via a bus.

The processor 210 is, for example, a central processing unit (CPU), and controls operations of the host device 20 as a whole. The processor 210 causes the host device 20 to transition to a sleep mode according to a predetermined condition, for example. The processor 210 transmits a difference notification request to the memory system 10 via the memory interface circuit 230 before causing the host device 20 to transition to the sleep mode. Upon receiving the size information from the memory system 10 in response to the difference notification request, the processor 210 adjusts (e.g., differentiates) a timing of transmitting a sleep request to the memory system 10, and transmits an additional write request.

The buffer memory 220 is, for example, a semiconductor memory such as an SRAM or a DRAM, and is used as a working region of the processor 210. The memory interface circuit 230 is connected to the memory system 10 and executes data communication with the memory system 10. The buffer memory 220 may be embedded in the host device 20, or may be provided outside the host device 20.

### 4. Configuration of Semiconductor Memory Device

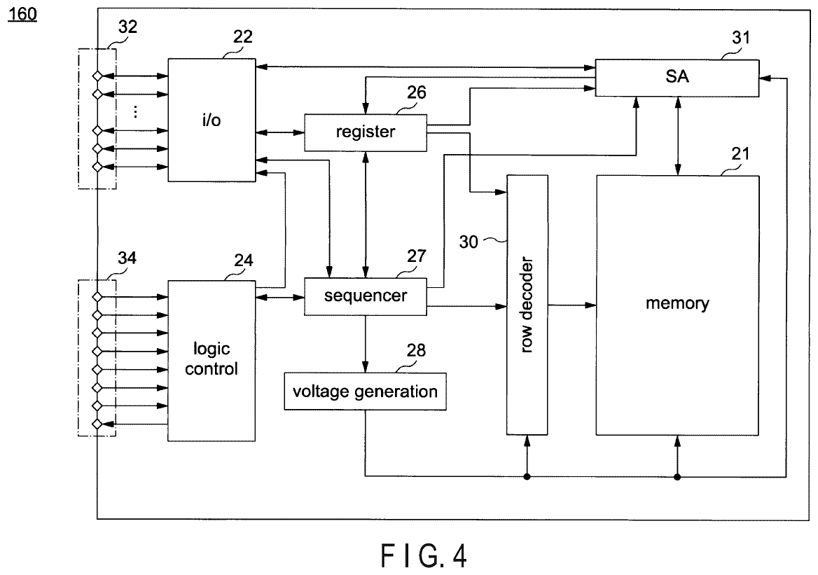

An example of the configuration of the semiconductor memory device according to the present embodiment will be described with reference to FIG. 4. The semiconductor memory devices 160 to 190 have the same configuration. For this reason, out of the configurations of the semiconductor memory devices 160 to 190, the configuration of the semiconductor memory device 160 will be described below, and the configurations of the semiconductor memory devices 170 to 190 will not be described. However, each of the semiconductor memory devices 160 to 190 may have a different configuration.

As illustrated in FIG. 4, the semiconductor memory device 160 includes a memory cell array 21, an I/O circuit 22, a logic control circuit 24, a register 26, a sequencer 27, a voltage generation circuit 28, a row decoder 30, a sense amplifier (SA) 31, an I/O pad group 32, and a logic control pad group 34.

Although details will be described below, the memory cell array 21 a plurality of non-volatile memory cells (memory cell transistors MT, which will be described below) associated with word lines and bit lines.

The I/O circuit 22 transmits and receives data signals to and from memory controller 100. The I/O circuit 22 transfers commands and addresses in the data signals to the register 26. The I/O circuit 22 transmits and receives write data and read data to and from the sense amplifier 31.

The logic control circuit 24 receives, for example, the chip enable signal, the command latch enable signal, the address latch enable signal, the write enable signal, the read enable signal, the output instruction signal, and the write protect signal from the memory controller 100. The logic control circuit 24 transmits the ready/busy signal to the memory controller 100 and notifies the memory controller 100 of the state of the semiconductor memory device 160.

The register 26 stores the commands and the addresses. The register 26 transfers the addresses to the row decoder 30 and the sense amplifier 31, and transfers the commands to the sequencer 27. The sequencer 27 receives the commands and controls the semiconductor memory device 160 as a whole according to a sequence based on the received commands.

The voltage generation circuit 28 generates voltages necessary for the data write operation, the data read operation, and the data erase operation, for example, based on an instruction from the sequencer 27. The voltage generation circuit 28 includes a plurality of drivers, and supplies the generated voltage to the row decoder 30 and the sense amplifier 31 according to the control of the sequencer 27. The voltage generation circuit 28 supplies the generated voltage to the corresponding row decoder 30 based on, for example, a row address included in the instructed address.

The row decoder 30 selects a memory cell corresponding to the row address included in the instructed address according to the control of the sequencer 27. The voltage supplied from a driver set 29 via the row decoder 30 is applied to the memory cell in the selected row.

During the data read operation, the sense amplifier 31 detects read data read from the memory cell to the bit line and transfers the detected read data to the I/O circuit 22. During the data write operation, the sense amplifier 31 transfers data to be written to the memory cell via the bit line. The sense amplifier 31 transfers data corresponding to the instructed data to the I/O circuit 22 according to the control of the sequencer 27.

The I/O pad group 32 transfers the data signal, which is received from the memory controller 100, to the I/O circuit 22. The I/O pad group 32 transfers the data signal, which is received from the I/O circuit 22, to the memory controller 100. The logic control pad group 34 transfers various signals, which are received from the memory controller 100, to the logic control circuit 24.

### 5. Configuration of Memory Cell Array

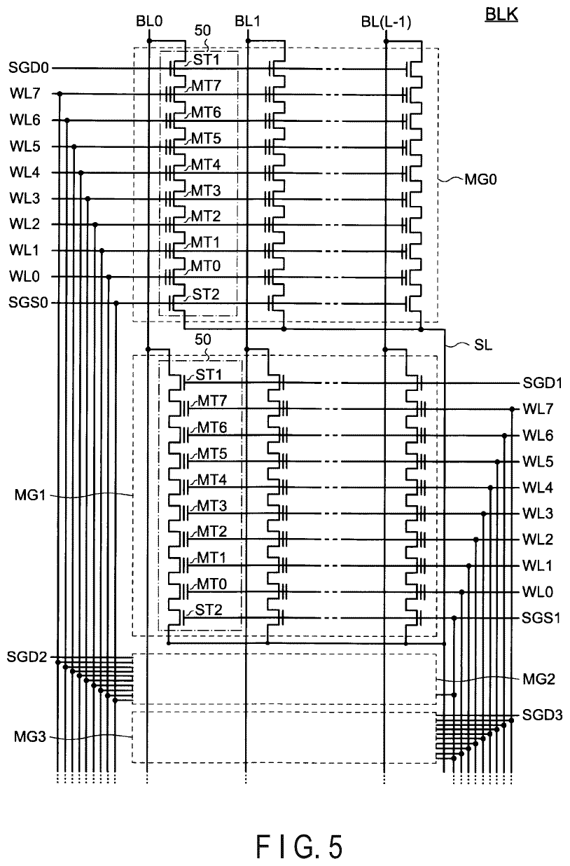

A circuit configuration of the memory cell array 21 will be described with reference to FIG. 5. FIG. 5 is an equivalent circuit diagram of a block BLK. As illustrated in FIG. 5, the block BLK includes a plurality of memory groups MG (MG0, MG1, MG2, . . . ). Each of the memory groups MG includes a plurality of strings 50.

In the present embodiment, the string 50 includes eight memory cell transistors MT (MT0 to MT7) and two select transistors ST (ST1 and ST2). The eight memory cell transistors MT are connected in series between a source of the select transistor ST1 and a drain of the select transistor ST2.

In the present embodiment, the number of memory cell transistors MT in the string 50 is eight, but the present invention is not limited thereto. For example, the number of memory cell transistors MT in the string 50 may be seven or less, or nine or more. The number of select transistors ST is also not limited to the above configuration.

Although details will be described below, the memory cell transistor MT includes a gate electrode that controls an on state and an off state of the transistor and a charge storage layer that stores charges injected by the write operation. The memory cell transistor MT has a threshold voltage according to the amount of charges stored in the charge storage layer, and is turned on when a voltage equal to or greater than the threshold voltage is applied to the gate electrode.

When a write operation is performed on the memory cell transistor MT, that is, when electrons are injected into the charge storage layer of the memory cell transistor MT, the threshold voltage of the memory cell transistor MT changes. When the memory cell is an N-type transistor, the threshold voltage of the memory cell transistor MT in a state where electrons are injected into the charge storage layer is higher than the threshold voltage of the memory cell transistor MT in a state where electrons are not injected into the charge storage layer. The memory cell transistor MT stores data in a non-volatile manner due to the change in the threshold voltage caused by the injection of electrons into the charge storage layer.

As illustrated FIG. 5, gates of the select transistors ST1 in memory groups MG are connected to a select gate lines SGDs (SGD0, SGD1, . . . ), respectively. Gates of the select transistors ST2 are connected to select gate lines SGS (SGS0, SGS1, . . . ), respectively. The select gate lines SGD and SGS are independently controlled by the row decoder 30. In the present embodiment, each of the select gate lines SGD and SGS is provided one, but is not limited thereto. Each of the select gate lines SGD and SGS may be provide two or more. In other words, the select transistors ST1 and ST2 may be provided two or more.

Gate electrodes of the memory cell transistors MT0 to MT7, which is included in the same memory group MG and belong to different bit lines BL, are connected to word lines WL0 to WL7, respectively. The word lines WL (WL0 to WL7) are independently controlled by the row decoder 30.

The block BLK is, for example, an erase unit of data. In other words, data stored by the memory cell transistors MT in the same block BLK are erased collectively. When the memory cell is an N-type transistor, the threshold voltage of the memory cell transistor MT in a state where data has been erased (erased state) is lower than the threshold voltage of the memory cell transistor MT in a state where data has been written (written state).

In the memory cell array 21, drains of the select transistors ST1 of the plurality of strings 50 arranged in the same column are connected to common bit lines BL (BL0 to BL (L−1) (L being a natural number of 3 or more)), respectively. In the memory cell array 21, sources of the plurality of select transistors ST2 are commonly connected to a source line SL.

The memory cell transistor MT includes a channel portion, a charge storage layer, and a gate electrode. The channel portion is a portion that functions as a channel of the memory cell transistor MT. The charge storage layer stores the charges injected by the write operation. The threshold voltage of the memory cell transistor MT changes depending on the amount of charges stored in the charge storage layer. The gate electrode is connected to a word line WL. The channel portion, the charge storage layer, and the gate electrode are insulated from each other by an insulating layer.

The charge storage layer may be, for example, a floating gate such as a metal layer, or a charge trap layer such as a silicon nitride layer. The memory cell transistor MT may be a memory cell including a ferroelectric insulating layer. In this case, the ferroelectric insulating layer is provided between the channel portion and the gate electrode, and the threshold of the memory cell transistor MT changes as a dielectric constant changes.

The select transistor ST includes a channel portion and a gate electrode. The select transistor ST does not include a charge storage layer. The gate electrode of the select transistor ST1 is the select gate line SGD. The gate electrode of the select transistor ST2 is connected to the select gate line SGS. Unlike the example of FIG. 5, the select transistor ST may include a charge storage layer.

### 6. Threshold Voltage Distribution of Memory Cell

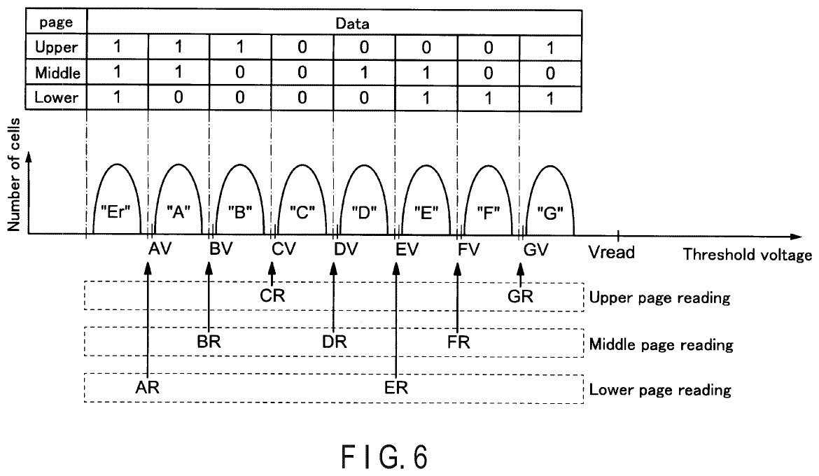

FIG. 6 is a diagram illustrating a threshold voltage distribution of the memory cell used as the memory cell according to the embodiment. In FIG. 6, a triple level cell (TLC) will be described as an example of a threshold voltage distribution. However, a hexa level cell (HLC), a penta level cell (PLC), a quad level cell (QLC), and a multi level cell (MLC) may also be used in the memory system 10. One memory cell can store m bits (m being an integer of 1 or more), the memory cell is an MLC when m is 2, the memory cell is a TLC when m is 3, the memory cell is a QLC when m is 4, the memory cell is a PLC when m is 5, and the memory cell is an HLC when m is 6. In addition, 2^{m} distributions are formed in the threshold voltage distribution in each level cell. The memory cell illustrated in FIG. 6 is a TLC (m=3), and thus there are eight threshold voltage distributions as illustrated in FIG. 6.

FIG. 6 illustrates examples of a threshold voltage distribution of each of the memory cells, assignment of data, and read voltage. A vertical axis of the threshold voltage distribution corresponds to the number of memory cells (Number of cells) and a horizontal axis corresponds to a threshold voltage Vth (Threshold voltage) of the memory cell.

For the memory cell of the TLC mode, each of the eight threshold voltage distributions may be referred to as a write level. The write levels are referred to as an “Er” level, an “A” level, a “B” level, a “C” level, a “D” level, an “E” level, an “F” level, and a “G” level in order from lowest threshold voltage. The “Er” level indicates an erased state. The memory controller 100 repeats program and verify operations on a memory cell that is at the “Er” level to cause the memory cell to transition to any one state of the “A” level to the “G” level. The program operation is an operation that changes the threshold voltage of the memory cell toward a high voltage. The verify operation is an operation that determines whether the threshold voltage of the memory cell, which has been changed by the program operation, reaches any one state of the “A” level to the “G” level.

To these write levels, for example, different pieces of 3-bit data are assigned as follows. The pieces of 3-bit data are referred to as a lower bit (Lower), a middle bit (Middle), and an upper bit (Upper).

In the present embodiment, the write levels and the 3-bit data correspond to each other as follows.
“Er” level: “111” data
“A” level: “110” data
“B” level: “100” data
“C” level: “000” data
“D” level: “010” data
“E” level: “011” data
“F” level: “001” data
“G” level: “101” data

The above 3-bit data is expressed in the order of Upper, Middle, and Lower.

A set of lower bits stored by the memory cells connected to the same word line is referred to as a lower page, a set of middle bits is referred to as a middle page, and a set of upper bits is referred to as upper page. For example, a write operation and a read operation for data are performed in units of pages.

Between adjacent threshold voltage distributions, verify voltages are set to be used in the write operation. Specifically, verify voltages AV, BV, CV, DV, EV, FV, and GV are set corresponding to the “A” level, the “B” level, the “C” level, the “D” level, the “E” level, the “F” level, and the “G” level, respectively.

For example, the verify voltage AV is set between the maximum threshold voltage at the “Er” level and the minimum threshold voltage at the “A” level. When the verify voltage AV is applied to the memory cell transistors, the memory cell transistors having the threshold voltage within the “Er” level are turned on, and the memory cell transistors having the threshold voltage within the threshold voltage distribution of the “A” level or higher are turned off.

The other verify voltages BV, CV, DV, EV, FV, and GV are also set, similarly to the verify voltage AV. The verify voltage BV is set between the “A” level and the “B” level. The verify voltage CV is set between the “B” level and the “C” level. The verify voltage DV is set between the “C” level and the “D” level. The verify voltage EV is set between the “D” level and the “E” level. The verify voltage FV is set between the “E” level and the “F” level. The verify voltage GV is set between the “F” level and the “G” level.

Between adjacent threshold voltage distributions, read voltages are set to be used in the read operation. For example, a read voltage AR is set between the maximum threshold voltage at the “Er” level and the minimum threshold voltage at the “A” level to determine whether the threshold voltage of the memory cell is included in the “Er” level or is included in the “A” level or higher. The read voltage AR is smaller than the verify voltage AV. However, the read voltage AR may be the same as the verify voltage AV.

The other read voltages BR, CR, DR, ER, FR, and GR are also set between adjacent levels, similarly to the read voltage AR. For example, the read voltage BR is set between the “A” level and the “B” level. The read voltage CR is set between the “B” level and the “C” level. The read voltage DR is set between the “C” level and the “D” level. The read voltage ER is set between the “D” level and the “E” level. The read voltage FR is set between the “E” level and the “F” level. The read voltage GR is set between the “F” level and the “G” level.

During the read operation, a read voltage Vread is supplied to an non-select WL (a word line WL not subject to the read operation) to forcibly cause the memory cell transistor MT corresponding to the non-select WL to enter an ON state. The voltage Vread is set to a voltage higher than the maximum threshold voltage of the highest threshold voltage distribution (for example, the “G” level). The memory cell transistor MT, in which the voltage Vread is applied to the gate, enters an ON state regardless of the data to be stored.

When the above-described data assignment is applied, one page data of the lower bits (data of the lower page) in the read operation is defined according to a reading result using the read voltages AR and ER. One page data of the middle bits (data of the middle page) is defined according to a reading result using the read voltages BR, DR, and FR. One page data of the upper bits (data of the upper page) is defined according to a reading result of the read voltages CR and GR.

In this way, since the data of the lower page, the middle page, and the upper page are defined by two, three, and two read operations, respectively, the assignment of data is referred to as a “2-3-2 code”. The assignment of data in each of the memory cells is not limited to the example of the “2-3-2 code” illustrated in FIG. 6. For example, the assignment of data may be a “1-3-3 code”. In addition, when the memory cell is a QLC (n=4), 16 threshold voltage distributions exist, and the assignment of data may be, for example, a “1-2-4-8 code” or a “3-4-4-4 code”.

### 7. Non-Volatilization Processing in Comparative Example

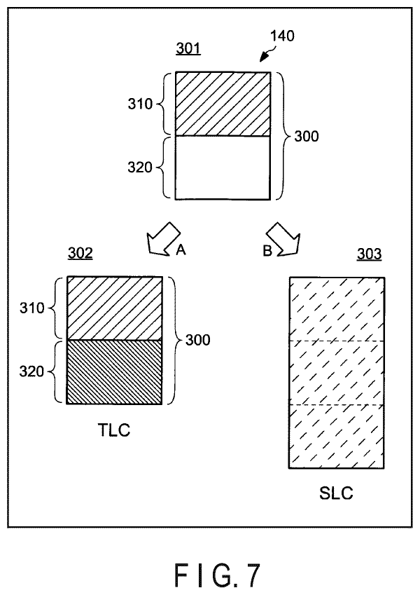

FIG. 7 is a diagram illustrating a method of non-volatilization processing for data in a semiconductor memory device of a comparative example. FIG. 7 illustrates a case, when the host device 20 transitions to a sleep mode, the memory system 10 receiving a sleep request from the host device 20 executes non-volatilization processing on the volatile memory (second buffer memory 140) using a TLC mode.

As illustrated in FIG. 7, the first data amount 300 is divided into a first region 310 and a second region 320. In the following description, that data is stored in the second buffer memory 140 of the first region 310 means that data is stored in the first region 310″. That data is stored in the second buffer memory 140 of the second region 320 means that data is stored in the second region 320. In a first state 301, the write data received from the host device 20 is stored as cache data in the first region 310. On the other hand, no data is stored in the second region 320. A description will be made with respect to non-volatilization processing in a case where the memory system 10 receives a sleep request from the host device 20 in such a state.

In FIG. 7, two types of non-volatilization processing are illustrated. In first non-volatilization processing A, when the memory system 10 receives a sleep request, dummy data is written to the second region 320 in which no data is stored, whereby the first data amount 300 is filled. In the non-volatilization processing A in a second state 302, the non-volatilization processing is executed by the TLC mode on the data stored in the first region 310 and the dummy data stored in the second region 320 as one unit. In a case of the non-volatilization processing A, the data in the second region 320 is unnecessary data for the host device 20.

In second non-volatilization processing B, when the memory system 10 receives a sleep request, the data stored in the first region 310 is subjected to non-volatilization processing by an SLC mode. As described above, the TLC mode enables storing of three bits of data in one memory cell, whereas the SLC mode enables storing of only one bit of data in one memory cell. For this reason, as illustrated in a third state 303, a capacity of the non-volatile memories (semiconductor memory devices 160 to 190) consumed when the non-volatilization processing is executed by the SLC mode is three times a capacity of the non-volatile memories consumed when the non-volatilization processing is executed by the TLC mode.

As described above, according to the semiconductor memory device of the comparative example, when the memory system 10 receives the sleep request, the space of the non-volatile memory is unnecessarily consumed if the write data received from the host device 20 does not reach the first data amount 300. In the following description, the amount of write data that has been received from the host device 20 (i.e., the amount of data temporarily stored in the first region 310) may be referred to as the “second data amount 310”. In this case, the amount of data in the second region 320 corresponding to a difference between the first data amount 300 and the second data amount 310 is the amount of shortage data (the first data amount 300) for executing the non-volatilization processing by the TLC mode. Such an amount of shortage data may be referred to as a “remaining size”.

### 8. Non-Volatilization Processing in Present Embodiment

In the information processing system 1 according to the present embodiment, the host device 20 transmits a difference notification request before transmitting a sleep request to the memory system 10. As in FIG. 7, the difference notification request is a request to notify of the difference between the first data amount 300 and the second data amount 310. Upon receiving the difference notification request, the memory system 10 calculates a remaining size indicating the difference between the first data amount 300 and the second data amount 310, and transmits size information including the remaining size to the host device 20.

When it becomes necessary for the host device 20 to transition to the sleep mode, the host device 20 changes a timing of transmitting the sleep request based on the size information received from the memory system 10. Specifically, even when it becomes necessary for the host device 20 to transition to the sleep mode, the host device 20 transmits an additional write request to write data of the amount equivalent to the remaining size to the memory system 10, and then transmits the sleep request. In other words, the memory controller 100 transmits the size information indicating the difference to the host device 20, and then executes the non-volatilization processing in response to the sleep request transmitted from the host device 20 to cause the memory system 10 to transition to a sleep mode.

In the above operation, after requesting the additional write, the host device 20 transmits the sleep request to the memory system 10 without transmitting the difference notification request again. Alternatively, the host device 20 may transmit a difference notification request after requesting the additional write. In this case, the memory system 10 calculates a remaining size indicating a difference between the total amount of data stored in the second buffer memory 140 after the additional write and the first data amount 300 in response to the difference notification request, and transmits size information including the remaining size to the host device 20. The host device 20 transmits a sleep request to the memory system 10 when the total amount of data reaches the first data amount 300 based on the size information received from the memory system 10.

In this case, the data stored in the second buffer memory 140 before the additional write may be referred to as “first write data 310”. The difference notified to the host device 20 from the memory system 10 before the additional write may be referred to as a “first difference”. The data stored in the second buffer memory 140 by the additional write may be referred to as “second write data”. The difference notified to the host device 20 from the memory system 10 after the additional write may be referred to as a “second difference”.

In the present embodiment, the non-volatilization processing is executed by the TLC mode I the same manner as illustrated in FIG. 7. In other words, the memory controller 100 is configured to store the write data stored in the volatile memory (the second buffer memory 140) for each first data amount 300 in the non-volatile memories (the semiconductor memory devices 160 to 190). However, the non-volatilization processing in the present embodiment may be executed by other modes without being limited to the TLC mode. In other words, the non-volatile memory in the present embodiment includes memory cells capable of storing n bits (n being an integer of 3 or more).

In the present embodiment, the non-volatilization processing by the TLC mode is executed for each first data amount 300. The first data amount 300 is, for example, 1k byte or more and 128k bytes or less.

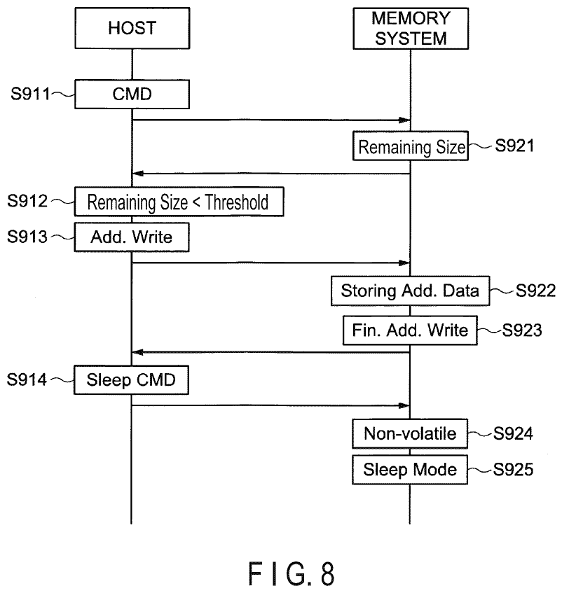

FIG. 8 is a sequence diagram illustrating an operation of an information processing system according to the embodiment. FIG. 8 illustrates processing of each of the memory system 10 and the host device 20. The processing of the memory system 10 is achieved by the memory controller 100. The processing of the host device 20 is achieved by the host controller 200.

As illustrated in FIG. 8, first, the host device 20 transmits a difference notification request to the memory system 10 (step S911; CMD). In the present embodiment, the difference notification request is transmitted when conditions for causing the host device 20 to transition to the sleep mode are met. However, the difference notification request may be transmitted at a predetermined time interval, or may be transmitted based on predetermined processing of the host device 20. In other words, the host device 20 transmits the difference notification request to the memory system 10 before transmitting the sleep request to the memory system 10 based on a predetermined condition.

Upon receiving the difference notification request transmitted in S911, the memory system 10 calculates the remaining size (see FIG. 7) indicating the difference between the first data amount 300 and the second data amount 310, and transmits the size information including the remaining size to the host device 20 (step S921; Remaining Size). In the present embodiment, the method has been described in which the memory system 10 calculates the remaining size, but the present invention is not limited to such a method. For example, the memory system 10 receiving the difference notification request may transmit, as size information, the first data amount 300 and the second data amount 310, or only the second data amount 310 to the host device 20. The size information may include information that specifies a mode (for example, a TLC mode) by which the non-volatilization processing is performed in the memory system 10.

Upon receiving the size information transmitted in S921, the host device 20 determines whether the non-volatilization processing is ready to be performed. Although details will be described below, such a determination is performed based on the size information received from the memory system 10. Specifically, when the remaining size in the size information is greater than a threshold (or equal to or greater than the threshold), the host device 20 determines that the non-volatilization processing is ready to be performed, and when the remaining size is equal to or less than the threshold (or less than the threshold), the host device 20 determines that the non-volatilization processing is not ready to be performed. Such a threshold is, for example, ½, ⅓, or ¼ of the first data amount 300. In other words, when the remaining size is greater than ½, ⅓, or ¼ of the first data amount 300, the host device 20 determines that non-volatilization processing of the memory system 10 is ready to be performed. The value (ratio) of the threshold can be set appropriately.

FIG. 8 illustrates an example where the remaining size is equal to or less than the threshold in determining whether the non-volatilization processing is ready to be performed, and the host device 20 determines that the non-volatilization processing is not ready to be performed (step S912; Remaining Size<Threshold). In this case, the host device 20 transmits an additional write request for the amount of data at least equivalent to the remaining size to the memory system 10 (step S913; Add. Write). The additional write may be executed in accordance with a single write request, or a plurality of write requests.

Upon receiving the additional write request in S913, the memory system 10 stores the write data according to the additional write request in the volatile memory (the second buffer memory 140) (step S922; Storing Add. Data). The memory system 10 notifies the host device 20 that the additional write data is stored (step S923; Fin. Add. Write). Upon receiving the notification that the additional write has been completed in S923, the host device 20 transmits a sleep request to the memory system 10 (step S914; Sleep CMD).

In the example of FIG. 8, the method has been described in which the host device 20 transmits the sleep request to the memory system 10 after confirming that the additional write has been completed, but the present invention is not limited to the method. For example, when the amount of data to be written in accordance with the additional write request reaches the amount of data corresponding to the remaining size, the host device 20 may transmit the sleep request to the memory system 10 without waiting for the notification from the memory system 10.

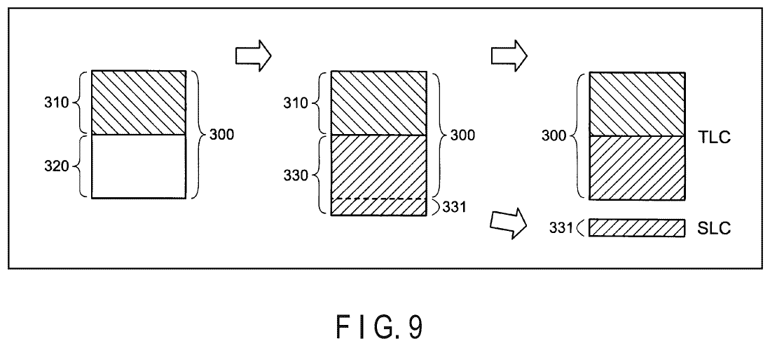

Upon receiving the sleep request in S914, the memory system 10 executes non-volatilization processing (step S924; Non-volatile). Here, the non-volatilization processing executed after the additional write will be described with reference to FIG. 9. FIG. 9 is a diagram illustrating a non-volatilization processing method for data in the semiconductor memory device according to the embodiment. As illustrated in FIG. 9, the second write data 330 is written to the second buffer memory 140 by the additional write in order to fill the remaining size corresponding to the second region 320.

Some of the second write data 330 written by the additional write exceed the first data amount 300. The exceeding amount of data is referred to as an excess amount of data 331. When the excess amount of data 331 is equal to or less than a threshold, the memory system 10 performs the non-volatilization processing with respect to the data of the first data amount 300 using the TLC mode, and performs the non-volatilization processing with respect to the data of the excess amount 331 using the SLC mode. After the non-volatilization processing in S924 is completed, the memory system 10 transitions to the sleep mode (step S925; Sleep Mode).

In the example of FIG. 9, the configuration has been described in which the non-volatilization processing is performed with respect to the first write data 310 written before the additional write and some of the second write data 330 written by the additional write using the TLC mode, but the present invention is not limited to such a configuration. For example, the non-volatilization processing may be performed with respect to all of the second write data 330 using the TLC mode, and the non-volatilization processing may be performed with respect to some or all of the data included in the first data amount 300 using the SLC mode.

In the example of FIG. 9, the configuration has been described in which the non-volatilization processing is performed with respect to the data of the first data amount 300 using the TLC mode and the non-volatilization processing is performed with respect to the data of the excess amount 331 using the SLC mode, but the present invention is not limited to such a configuration. For example, the non-volatilization processing may be performed with respect to the data of the first data amount 300 using a mode other than the TLC mode. Furthermore, in this case, the non-volatilization processing may be performed with respect to the data of the excess amount 331 using a mode other than the SLC mode.

In other words, the memory controller 100 stores the data (first data) of the first data amount 300, out of the first write data 310 written before the additional write and the second write data 330 written by the additional write in the non-volatile memory, using a first mode (for example, TLC mode), and stores the data (second data) in the excess amount 331, out of the first write data 310 and the second write data 330, in the non-volatile memory using a second mode (for example, SLC mode).

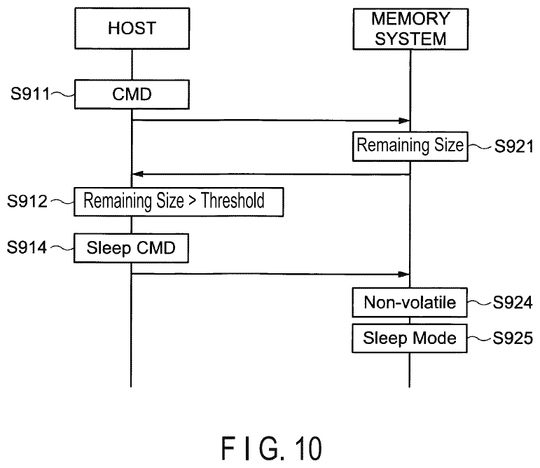

FIG. 10 is a sequence diagram illustrating the operation of the information processing system according to the embodiment. FIG. 10 is similar to FIG. 8, but FIG. 8 illustrates the case where the remaining size is equal to or less than the threshold in S912 and the host device 20 determines that the non-volatilization processing of the memory system 10 is not ready to be performed, whereas FIG. 10 illustrates a case the remaining size is greater than the threshold in determining whether the non-volatilization processing is ready to be performed and the host device 20 determines that the non-volatilization processing of the memory system 10 is ready to be performed (step S912; Remaining Size>Threshold).

As illustrated in FIG. 10, the host device 20 determines in S912 that the non-volatilization processing of the memory system 10 is ready to be performed, and thus S913 (transmitting the additional write request), S922 (storing the additional write data), and S923 (notifying completion of storage) in FIG. 8 are not illustrated. In this case, since the additional write is not performed, the memory system 10 performs the non-volatilization processing in S924 with respect to the first write data 310 of the first data amount 300 using the SLC mode. The other steps are the same as those in FIG. 8, and thus will not be described.

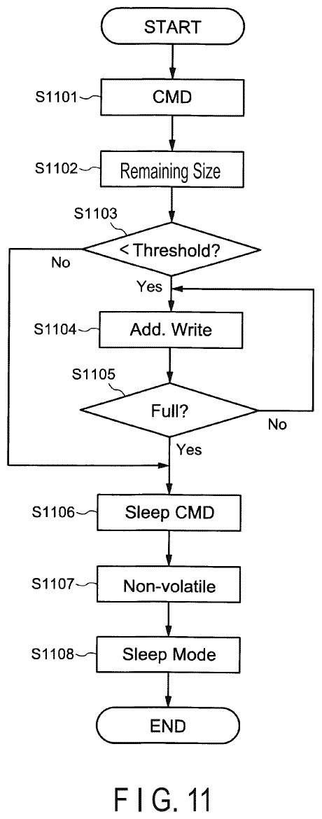

FIG. 11 is a flowchart illustrating the operation of the information processing system according to the embodiment. FIG. 11 illustrates an operation flow including the sequences illustrated in FIGS. 8 and 10. First, as in S911, the host device 20 transmits the difference notification request to the memory system 10 (step S1101; CMD). As in S921, the memory system 10 transmits the size information including the remaining size of the volatile memory (second buffer memory 140) to the host device 20 (step S1102; Remaining Size).

Upon receiving the size information in S1102, the host device 20 compares the remaining size in the size information with the threshold, as in S912, to determine whether the non-volatilization processing is ready to be performed in the memory system 10 (step S1103; <Threshold?). As described above, the threshold is, for example, ½, ⅓, or ¼ of the first data amount 300.

When the host device 20 determines in S1103 that the remaining size is equal to or less than the threshold (“Yes” in S1103), the host device 20 transmits the additional write request for the amount of data equivalent to the remaining size to the memory system 10 as in S913 without transitioning to the sleep mode (step S1104; Add. Write).

On the other hand, it is determined in S1103 that the remaining size is greater than the threshold (“No” in S1103), the host device 20 transmits the sleep request to the memory system 10 as in S914 without transmitting the additional write request (step S1106; Sleep CMD). In other words, when the remaining size is greater than the threshold, the memory system 10 transitions to the sleep mode in response to the sleep request without receiving the additional data from the host device 20. Similarly, in this case, the host device 20 also transitions to the sleep mode.

After the additional write in S1104, the host device 20 determines whether the amount of data filled by the additional write reaches the amount of data equivalent to the remaining size (whether the first data amount 300 is filled) (step S1105; <Full?). When the host device 20 determines in S1105 that the first data amount 300 is filled by the additional write (“Yes” in S1105), the process proceeds to S1106. On the other hand, when the host device 20 determines in S1105 that the first data amount 300 is not filled even after the additional write is performed (“No” in S1105), the process returns to S1104. When the amount of data equivalent to the remaining size is written by one additional write in S1104, step S1105 may be omitted.

Upon receiving the sleep request transmitted from the host device 20 in S1106, the memory system 10 executes the non-volatilization processing (step S1107; Non-volatile) as in S924, and both the memory system 10 and the host device 20 transition to the sleep mode as in S925 (step S1108; Sleep Mode).

As described above, according to the information processing system 1 of the present embodiment, when the sleep request is received from the host device 20, it is possible to reduce the consumption of the non-volatile memory in the comparative example described with reference to FIG. 7. Accordingly, it is possible to improve efficiency of the non-volatilization processing in the memory system 10.

While the present invention has been described with reference to the accompanying drawings, the present invention is not limited to the above embodiment, and can be appropriately modified without departing from the spirit of the present invention. For example, even when a person skilled in the art appropriately adds or deletes the components, or changes the design of the information processing system of the present embodiment, such an information processing system is also included in the scope of the present invention as long as including the gist of the present invention. Furthermore, the configurations described above can be appropriately combined as long as there is no mutual inconsistency, and technical matters common to the configurations are included in the configurations even if not being explicitly described.

Even when there are other operational effects different from those brought about by the aspects of above-described components, it is understood that operational effects that are apparent from the description of the description or that can be easily anticipated by those skilled in the art are of course brought about by the invention.

What is claimed is

1. A memory system connectable to an information processing device, the memory system comprising:
a non-volatile memory including a plurality of memory cells;
a volatile memory; and
a memory controller configured to:
write data of n bits of data (n being an integer of 3 or more) into each memory cell of the non-volatile memory;
perform non-volatilization to write data stored in the volatile memory into the non-volatile memory each time a second data amount, which is an amount of first write data that is currently stored in the volatile memory and has not been non-volatilized, reaches a first data amount; and
in response to a first request from the information processing device, transmit first size information indicating a first difference between the first data amount and the second data amount.

2. The memory system according to claim 1, wherein the memory controller is configured to perform the non-volatilization by writing the data of the first data amount by n bits into each memory cell of the non-volatile memory.

3. The memory system according to claim 1, wherein the memory controller is configured to perform non-volatilization of the first write data in response to a second request received from the information processing device after the first request.

4. The memory system according to claim 3, wherein the second request comprises a command to cause the volatile memory to turn into a sleep mode, during which power to the volatile memory is shut off.

5. The memory system according to claim 1, wherein the memory controller is configured to write second write data that is received from the information processing device after the first request and before the first write data is non-volatilized, into the volatile memory.

6. The memory system according to claim 5, wherein the memory controller is configured to transmit, to the information processing device, second size information indicating a second difference between the first data amount and a total amount of the first and second write data stored in the volatile memory, the total amount being less than the first data amount.

7. The memory system according to claim 6, wherein the memory controller is configured to perform non-volatilization of the first and second write data in response to a second request received from the information processing device after the second size information has been transmitted to the information processing device.

8. The memory system according to claim 7, wherein the second request comprises a command to cause the volatile memory to turn into a sleep mode, during which power to the volatile memory is shut off.

9. The memory system according to claim 5, wherein the memory controller is configured to, when a total amount of the first and second write data exceeds the first data amount, perform non-volatilization of a first part of the first and second write data by writing m bits into each memory cell of the non-volatile memory (m being an integer equal to or greater than 1 and less than n), and non-volatilization of a second part of the first and second write data by writing n bits into each memory cell of the non-volatile memory.

10. The memory system according to claim 5, wherein the memory controller is configured to, when a total amount of the first and second write data exceeds the first data amount, perform non-volatilization of an exceeding part of the first and second write data by writing m bits into each memory cell of the non-volatile memory (m being an integer equal to or greater than 1 and less than n), and non-volatilization of a remaining part of the first and second write data, which is equivalent to the first data amount, by writing n bits into each memory cell of the non-volatile memory.

11. An information processing device connectable to a memory system including a non-volatile memory and a volatile memory, the information processing device comprising:
a controller configured to transmit, to the memory system, a first command to perform non-volatilization of data stored in the volatile memory into the non-volatile memory, wherein
the controller is configured to differentiate a timing of transmitting the first command based on size information received from the memory system, the size information indicating a difference between a first data amount and a second data amount,
the second data amount being an amount of data that is stored in the volatile memory and has not been non-volatilized into the non-volatile memory, the memory system performing the non-volatilization each time the second data amount reaches the first data amount.

12. The information processing device according to claim 11, wherein the controller is configured to compare the difference with a threshold amount, and differentiate the timing of transmitting the first command based on whether the difference is greater or less than the threshold amount.

13. The information processing device according to claim 12, wherein the controller is configured to:
transmit, to the memory system, a second command to write additional data into the volatile memory and then the first command, upon determining that the difference is less than the threshold amount; and
transmit the first command to the memory system, without transmitting the second command before the first command, upon determining that the difference is greater than the threshold amount.

14. The information processing device according to claim 13, wherein the controller is configured to set a size of the additional data to be equal to or greater than the first data amount.

15. The information processing device according to claim 13, wherein the controller is configured to transmit, to the memory system, the first command in response to a notification that the additional data has been written, when the difference is less than the threshold amount.

16. The information processing device according to claim 11, wherein the first command comprises a command to cause the volatile memory to turn into a sleep mode, during which power to the volatile memory is shut off.

17. The information processing device according to claim 11, wherein the controller is configured to transmit, to the memory system, a third command to return the size information.

18. The information processing device according to claim 17, wherein the controller is configured to transmit the third command when the controller operates to turn the information processing device into a host sleep mode.

19. The information processing device according to claim 17, wherein the controller is configured to turn the information processing device into the host sleep mode after transmitting the first command.

20. An information processing system comprising:
a memory system; and
an information processing device connectable to the memory system, wherein
the memory system includes:
a non-volatile memory including a plurality of memory cells;
a volatile memory; and
a memory controller configured to:
write data of n bits of data (n being an integer of 3 or more) into each memory cell of the non-volatile memory;
perform non-volatilization to write data stored in the volatile memory into the non-volatile memory each time a second data amount, which is an amount of first write data that is currently stored in the volatile memory and has not been non-volatilized, reaches a first data amount; and
in response to a first request from the information processing device, transmit first size information indicating a first difference between the first data amount and the second data amount,
the information processing device includes a controller configured to transmit, to the memory system, a second request to perform non-volatilization of data stored in the volatile memory into the non-volatile memory, and
the controller is configured to differentiate a timing of transmitting the second request based on the size information received from the memory system.
